(19) United States
(12) Patent Application Publication
(10) Pub. No.: US 2019/0062477 A1
(43) Pub. Date: Feb. 28, 2019

(54) CURABLE COMPOSITION

(71) Applicant: Macromol GmbH, Jena (DE)

(72) Inventors: Elisabeth Klemm, Weimar (DE); Wolfgang Fried, Jena (DE); Martin Tittel, Bad Berka (DE)

(21) Appl. No.: 16/087,415

(22) PCT Filed: Mar. 22, 2017
(86) PCT No.: PCT/EP2017/056864

§ 371 Date: Sep. 21, 2018

(30) Foreign Application Priority Data
Mar. 24, 2016 (DE) 10 2016 205 042.7

(51) Int. Cl. C08F 220/18; C08F 228/04; C08F 2/48; C08K 5/5397; C08K 5/07; G02B 1/04

(52) U.S. Cl. CPC C08F 220/18; C08F 228/04; C08F 2/48; C08F 2438/01; C08K 5/07; G02B 1/04; C08F 2800/20; C08K 5/5397

(57) ABSTRACT

The present invention relates to a curable composition which can be cured by radiation and/or the influence of temperature; a cured product which is obtained from such a composition; an object and a composite which have the cured composition; and a method for producing the same. The cured composition has a high refractive index.

The present invention relates to a curable composition that is curable by radiation and/or the effect of temperature, a cured product obtained from such composition, an object and a composite comprising the cured composition as well as a method for the production of same.

Compositions curable by radiation or the effect of temperature are known for coating and connecting objects, such as, for example, glass panes.

Such a known composition is disclosed in WO 02/31026 A2. The composition described in this document comprises an oligomeric reaction product resulting from the reaction of a polyfunctional thiol with [a compound having] two or more double bonds. The cured composition has a refractive index of at least 1.67 at 589 nm. From the composition can, in particular, be produced optical waveguides having a high refractive index.

The objective of the present invention is to provide a curable composition that is particularly suitable for connecting objects and that has a high index of refraction.

Disclosed is a curable composition comprising
a compound of formula (1)

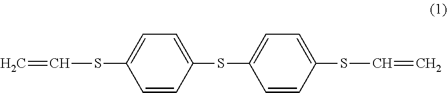 [SMILES: C=CSc1ccc(Sc2ccc(SC=C)cc2)cc1]

a compound of formula (2)

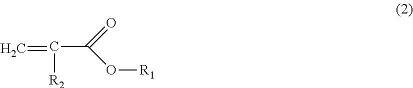

where R₁ is a straight-chain or branched alkyl moiety, preferably having 1-8 C atoms, an aryl moiety, a naphthyl moiety or a moiety having the formula —R₃—S-aryl, R₃—S-naphthyl, or R₃—S-alkyl, preferably R₃—S-naphthyl, —C₄H₉ or phenyl, where R₃ is a straight-chain or branched alkylene group, preferably having 1-8 C atoms, preferably a group of formula —CH₂CH₂— or —CH₂CH₂CH₂—, and where
R₂ is hydrogen or methyl,
at least one compound selected from a compound of formula (3) and a compound of formula (4)

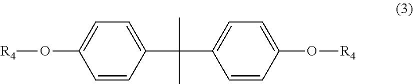

where R₄ is a moiety having the formula

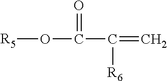

where R₅ is a straight-chain or branched alkylene group which may have one or several hydroxide substituents, preferably a group of formula —CH₂—CH(OH)—CH₂— and
where R₆ is hydrogen or methyl, preferably methyl,

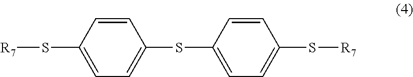

where R₇ is a moiety having the formula

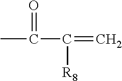

where R₈ is hydrogen or methyl.

The composition comprises one of the compounds (3) and (4) or both of the compounds (3) and (4).

The curable composition may comprise the following quantities of compounds (1), (2) as well as (3) and/or (4):
Compound (1): 64 to 89 wt %
Compound (2): 9 to 28 wt %
Compound (3) and/or (4): 2 to 8 wt %.

The combined total of compounds (1), (2) as well as (3) and/or (4) can be 100 wt % or additional substances, such as, for example, one of the photoinitiators or light-stabilization agents, listed below, may be present which, together with compounds (1), (2) as well as (3) and/or (4), may total 100 w %.

The composition is liquid and can be cured to form a solid, also referred to as cured product. The cured product is preferably transparent.

The curable composition can be curable by exposure to radiation and/or to temperature or heating. Conditions will be specified below.

The curable composition may comprise a photoinitiator selected from a hydroxy ketone, a monoacylphosphine, a bisacylphosphine or a benzoyl derivative or a mixture of one or several thereof.

The quantity of the photoinitiator is preferably 0.01 to 3.5 wt %.

The photoinitiator is preferably selected from 1-hydroxy-cyclohexyl-phenyl ketone, 2,4,6-trimethylbenzoylbisphenylphosphine oxide, bis(2,4,6-trimethylbenzoyl)phenylphosphine oxide, 2-hydroxy-2-methyl-1-phenylpropane-2-one, benzophenone or a mixture of one or several thereof.

The curable composition may contain a light-stabilization agent selected from bis(1-octyloxy-2,2,6,6-tetramethyl-4-piperidyl)sebacate, hydroxyphenylbenzotriazole, 2-hydroxy-benzophenone and/or 2-hydroxyphenyltriazine.

The quantity of the light-stabilization agent is preferably 0.01 to 5 wt %.

The curable composition can comprise a thermally splittable initiator from the group of catalysts known in atom transfer radical techniques or from peroxide compounds, preferably cumol hydroperoxide.

The curable composition can be cured to form a cured product, also referred to as cured composition. The invention also relates to a cured product obtained by curing a curable composition such as described above.

The cured product may be transparent. The cured product has in particular an index of refraction of 1.69 to 1.74 at a wavelength of 633 nm.

Unless stated differently, the refractive indices in the invention are determined at 25° C.

The term ‘transparent’ means ‘transmissive for light’, ‘substantially transmissive for light’ and/or ‘completely or largely transmissive for radiation of the visible spectrum’. A transmissivity [sic]

In a further aspect the invention relates to an object comprising the cured product. The object can be comprised of any desired material, such as glass, synthetic, metal, ceramic or of a combination thereof. The object may comprise the cured product at one or several sites, in particular as a coating covering at least a portion of a surface of the object.

The object is, in particular, a laminar object, in particular of plate shape. In the case of a transparent plate-shaped object, the term ‘pane’ is also applied.

The object may have a polished surface or said surface can be a polished surface.

Disclosed is, in particular, an object on one surface or a portion of a surface of which a coating of a cured product [is disposed] that is obtained by curing a curable composition as described above.

A coating can be of any desired extent and layer thickness. As a rule, the extent is limited by the dimensions of the object or of a surface to be coated. The layer thickness is preferably 10 nm to 2 mm.

The object is in particular a transparent object. In particular, the object has a refractive index of 1.69 to 1.74 at a wavelength of 633 nm. Preferred materials for a transparent object are glass or a synthetic material.

In a still further aspect the invention relates to a composite comprising
a first object,
a second object,
a layer of a cured product obtained by curing a curable composition as described above, wherein the layer is disposed between the first object and the second object.

The first object and the second object are preferably connected with one another by means of the layer. The layer of the cured product can form a connection under material closure or an adhesive connection between the objects.

The first object can be a transparent object.

The first object can have a refractive index of 1.69 to 1.74 at a wavelength of 633 nm.

The second object can be a transparent object.

The second object can have a refractive index of 1.69 to 1.74 at a wavelength of 633 nm.

The same disclosure may apply to the first object and the second object of the composite as for a previously described object that comprises the cured product. The first and the second object are, in particular, laminar objects, in particular of plate shape. In the case of a transparent plate-shaped object the term ‘pane’ can also be applied.

In one implementation the first object and the second object are a glass, a synthetic material, a metal or a ceramic. The first object can be of a different material than the second object, wherein any desired combination of said materials is feasible.

The composite can, in principle, comprise further objects (third, fourth, etc.) which are integrated into the composite in each instance by means of at least one further layer of a cured product.

In an especially advantageous implementation of a composite the first and the second object are a glass pane or a synthetic pane. The composite can thus be a laminated glass. The composite can comprise further glass panes/synthetic panes, that are joined by means of a further layer of a cured product to another, adjacent glass pane/synthetic pane. The structure of the composite can consequently be described as follows, wherein the layer of cured product is described as ‘layer’ for short.

Pane-layer-(pane-layer)ₙ-pane,
where n is zero or an integer, preferably an integer up to 10, preferably up to 5.

In a further aspect the invention relates to a method for coating a surface of an object, comprising
application of a curable composition as described above onto the surface of an object, or a portion of the surface,
curing the composition such that a layer of the cured composition is formed on the surface or on the portion of the surface.

Employing this method, an above described object can be obtained that comprises the cured product as a surface coating or partial surface coating. Reference is made to the preceding disclosure.

The layer of the cured composition has preferably a layer thickness of 10 nm to 2 mm.

The application of the curable composition can be carried out using diverse techniques, in particular spraying, dipping, squeegeeing, spin coating or using a manual, semi-automatic and/or fully automatic coating technique.

In the application of the curable composition, which is a liquid, a liquid film is form of the curable composition.

Disclosed in the invention is furthermore a method for connecting a first and a second object to form a composite, comprising
application of a curable composition as described above onto a surface of the first and/or onto a surface of the second object,
joining the first and the second object such that between the first and the second object the curable composition is disposed,
curing the composition such that a layer of the cured composition is formed between the first and the second object, by means of which the first object and the second object are connected with one another.

Employing such a method, an above described composite can be produced. Reference is made to the preceding disclosure.

The layer of the cured composition has preferably a layer thickness of 5 to 50 μm.

For the step of applying the curable composition, the same can apply as in the preceding methods for coating a surface of an object.

When joining the first and the second object, they are brought together on the side of said surfaces. Hereby a liquid film of the curable composition is formed between the objects, which film can subsequently be cured.

In the following curing conditions are specified which can be employed for curing the composition according to the invention or in methods described precedingly.

The composition can be cured photochemically by exposure to radiation in a wavelength range of 250 nm to 700 nm. The length of exposure is selected depending on the quantity or film thickness to be cured and is, for example, 1 to 15 minutes. When curing the composition by photochemical means, the composition preferably comprises a photoinitiator.

The composition can be cured thermally by being heated it to 40° C. to 140° C., preferably 40° C. to 120° C. The length of curing is selected depending on the quantity or film thickness to be cured and is, for example 10 to 120 minutes.

The invention will be described in the following with reference to embodiment examples.

### BRIEF DESCRIPTION OF THE FIGURES

FIG. 1 shows a composite according to the invention;

FIG. 2 shows an object according to the invention with coating.

### EXAMPLES

### Example 1: Production of the Curable Formulation; Suitable for Coatings and Joinings

In a reaction vessel 3.0 wt % of bis-(4-methacryloylthiophenyl)sulfide are dissolved at ambient temperature under continuous agitation in a substance mixture of 10 wt % of naphthalenethioethylacrylate and 87.0 wt % of bis-(4-vinylthiophenyl)sulfide.

To this solution are added 2.0 wt % of 2-hydroxy-2-methyl-1-phenyl-propane-1-one (Tradename DAROCUR 1173) as initiator and mixed homogeneously under agitation.

The pale yellow-colored solution is ready for use for coatings and joinings. The curing is carried out using a UVA source whose luminous intensity is at least 10 mW/cm². The upper limit for the radiative intensity is specified as 40 mW/cm². The length of time of irradiation depends on the coating thickness or joining thickness and, as a rule, is 5 minutes. Subsequently thermal holding at 80° C. for 1 h takes place.

Thin layers (up to a thickness of 50 μm) are colorless and transparent. Depending on the formulation composition, the refractive indices are 1.69 to 1.74 (25° C., 633 nm).

### Example 2: Composite

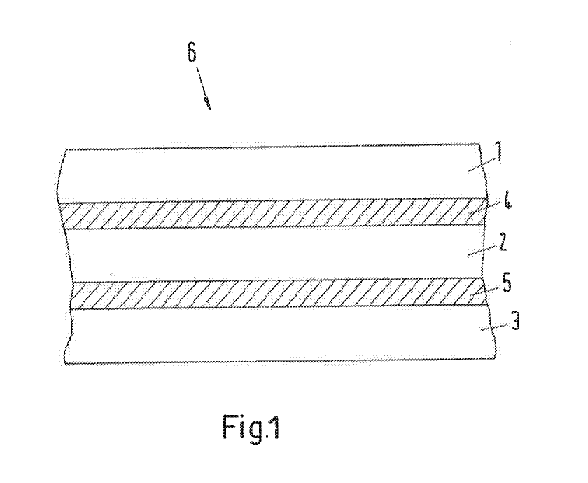

FIG. 1 shows a composite 6 of laminar objects, in this case glass panes 1, 2, 3, and layers 4, 5 of a cured product, each of which being disposed between two glass panes and firmly connecting them. The layers 4, 5 can be obtained by application and curing of a composition from Example 1.

The thicknesses are not drawn to scale. In practice layers 4, 5 are substantially thinner (approximately up to 50 μm). The glass of the glass panes 1, 2, 3 and the layers 4, 5 have a refractive index in the range of 1.69 to 1.74 at a wavelength of 633 nm.

### Example 3: Coated Object

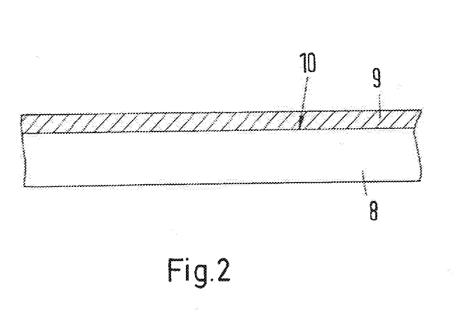

FIG. 2 shows an object 8 comprising on a surface 10 a layer of a cured product 9. Onto the object 8, here a glass pane, the layer 9 of a cured product is applied. The layer 9 can be obtained by application and curing of a composition from Example 1.

The thickness of layer 9 is here also not true to scale. It is depicted as being thicker than is the case in practice.

1. A curable composition comprising
a compound of formula (1) 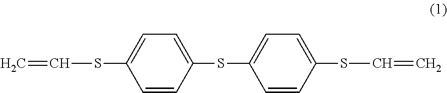 [SMILES: C=CSc1ccc(Sc2ccc(SC=C)cc2)cc1]
a compound of formula (2) 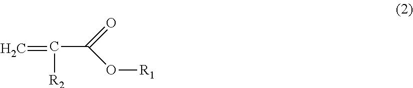
where R₁ is a straight-chain or branched alkyl moiety, an aryl moiety, a naphthyl moiety or a moiety having the formula —R₃—S-aryl, R₃—S-naphthyl, or R₃—S-alkyl,
where R₃ is a straight-chain or branched alkylene group, and where
R₂ is hydrogen or methyl,
at least one compound selected from a compound of formula (3) and a compound of formula (4) 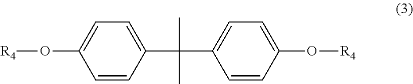
where R₄ is a moiety having the formula 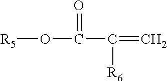
where R₅ is a straight-chain or branched alkylene group which may have one or several hydroxide substituents, and where
R₆ is hydrogen or methyl, 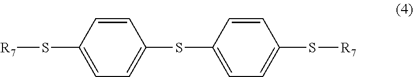
where R₇ is a moiety having the formula 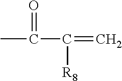
where R₈ is hydrogen or methyl.

2. A curable composition as in claim 1, comprising the following quantities of compounds (1), (2) as well as (3) and/or (4):
Compound (1): 64 to 89 wt %
Compound (2): 9 to 28 wt %
Compound (3) and/or (4): 2 to 8 wt %.

3. A curable composition as in claim 1, where R₁ is —R₃—S-naphthyl, —C₄H₉ or phenyl.

4. A curable composition as in claim 1, where R₃ is a group having the formula —CH₂CH₂— or —CH₂CH₂CH₂—.

5. A curable composition as in claim 1, where R₅ is a group having the formula —CH₂—CH(OH)—CH₂—.

6. A curable composition as in claim 1, where R₆ is methyl.

7. Curable A curable composition as in claim 1, comprising a photoinitiator selected from a hydroxy ketone, a monoacyl phosphine, a bisacyl phosphine or a benzoyl derivative or a mixture of one or several thereof.

8. A curable composition as in claim 1, where the photoinitiator is selected from 1-hydroxy-cyclohexyl-phenyl ketone, 2,4,6-trimethylbenzoylbisphenylphosphine oxide, bis(2,4,6-trimethylbenzoyl)phenylphosphine oxide, 2-hydroxy-2-methyl-1-phenylpropane-2-one, benzophenone or a mixture of one or several thereof.

9. A curable composition as in claim 1, comprising a light-stabilization agent selected from bis(1-octyloxy-2,2,6,6-tetramethyl-4-piperidyl)sebacate, hydroxyphenylbenzotriazole, 2-hydroxy-benzophenone and/or 2-hydroxyphenyltriazine.

10. A curable composition as in claim 1, comprising a thermally splittable initiator from the group of catalysts known in atom transfer radical techniques or from peroxide compounds.

11. A cured product obtained by curing a curable composition as in claim 1.

12. A cured product as in claim 11, having a refractive index of 1.69 to 1.74 at a wavelength of 633 nm.

13. An object comprising on a surface or a portion of a surface a layer of a cured product obtained by curing a curable composition as in claim 11.

14. An object as in claim 13, that is a transparent object, preferably having a refractive index of 1.69 to 1.74 at a wavelength of 633 nm.

15. An object as in claim 13 that is a glass, a synthetic or a ceramic.

16. A composite comprising
a first object,
a second object,
a layer of a cured product obtained by curing a curable composition as in claim 1, wherein the layer is disposed between the first object and the second object.

17. A composite as in claim 16, wherein the first object and the second object are connected with one another by means of the layer.

18. A composite as in claim 16, wherein the first object is a transparent object, preferably having a refractive index of 1.69 to 1.74 at 633 nm, and the second object is a transparent object, preferably having a refractive index of 1.69 to 1.74 at 633 nm.

19. A composite as in claim 16, wherein the first object and the second object are a glass, a synthetic or a ceramic.

20. A method for coating a surface of an object, the method comprising the steps of:
application of a curable composition as in claim 1 onto the surface of the object or onto a portion of the surface,
curing the composition such that a layer of the cured composition is formed on the surface.

21. A method for connecting a first and a second object to form a composite, the method comprising the steps of:
application of a curable composition as in claim 1 onto a surface of the first object and/or a surface of the second object,
joining the first object and the second object such that between the first and the second object the curable composition is disposed,
curing the composition such that a layer of the cured composition is formed between the first object and the second object by means of which the first object and the second object are connected with one another.

22. A method as in claim 20, wherein the composition is cured photochemically by exposure to radiation in a wavelength range of 250 nm to 700 nm.

23. A method as in claim 20, wherein the composition is cured by being heated to 40° C. to 140° C.
